(19) United States
(12) Patent Application Publication
(10) Pub. No.: US 2005/0063682 A1
(43) Pub. Date: Mar. 24, 2005

(54) [INTEGRATED CONTROL CHIP]

(76) Inventors: CHIN-LIANG WANG, HSINCHU (TW); YU-YU SUNG, HSINCHU (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/707,194

(22) Filed: Nov. 26, 2003

(30) Foreign Application Priority Data
Sep. 19, 2003 (TW) 92125863

(51) Int. Cl. H04N 5/781

(52) U.S. Cl. 386/125; 386/126

(57) ABSTRACT

An integrated control chip with power control for a DVD player is provided. The present invention integrates the VFD drive circuit and the function of a microprocessor into a single chip to reduce the cost and the circuit complexity. The integrated chip also can read the starting data from an EEPROM so that the user can control the DVD player by using a standard controller and while the DVD manufacturers may incorporate other features to better serve the consumers demand.

### CROSS REFERENCE TO RELATED APPLICATIONS

This application claims the priority benefit of Taiwan application serial no.92125863, filed on Sep. 19, 2003.

### BACKGROUND OF INVENTION

1. Field of the Invention

This invention generally relates to an integrated control chip, and more particularly to an integrated control chip with power control suitable for digital video disc (DVD) players.

2. Description of Related Art

As technology advances, multi-media devices are developed with better image and sound quality. To further increase the storage capacity, DVD has been developed to replace the traditional VCD. A DVD can provide a storage capacity several times that of a VCD. Hence, many DVD player manufacturers continue to provide better and affordable DVD players.

There is a vacuum fluorescent display (VFD) on the DVD player. The VFD drive circuit is controlled by the Motion Picture Experts Group (MPEG) system. The MPEG system also exchanges the control data with a microprocessor that controls the power. FIG. 1 is a block diagram of the power control system and the VFD drive circuit in a conventional DVD player. The MPEG system 101 is coupled to the microprocessor 102 and the VFD drive circuit 105 to exchange the control data and to drive the VFD 106. The user controls the external controller 103. The user can control the microprocessor 102 and the VFD drive circuit 105 via the external controller 103. Hence, when the user is going to control the power of the DVD player, the command is inputted via the external controller 103 to control the VFD drive circuit 105 and drive the VFD 106.

Hence, the conventional DVD player requires a microprocessor. Because a program is required for the microprocessor, the circuit complexity and the cost are high. In addition, there is no standard for the microprocessor; each DVD player manufacturer uses a different microprocessor to control the power. Consequently, different control methods are used, which is inconvenient to users.

### SUMMARY OF INVENTION

An object of the present invention is to provide a control chip integrated with power control suitable for DVD players. The present invention integrates the VFD drive circuit and the function of the microprocessor into a single chip and uses another means to replace the microprocessor to reduce the cost and the circuit complexity.

Another object of the present invention is to provide a standard interface so that the users can control the DVD player by using a standard controller and each DVD manufacturer can also add more features based upon their need.

The present invention provides an integrated control chip with power control for a DVD player, the DVD player including an MPEG system, a power control circuit and a VFD, the chip comprising: an MPEG interface between the MPEG system and the integrated control chip, the MPEG interface sending a starting data to the integrated control chip; a VFD drive circuit, coupled to the MPEG interface, driving the VFD; an external control signal receiver receiving an external control signal; a starter control circuit, coupled to the external control signal receiver, determining whether the power control circuit turns on the DVD player based on the external control signal; and a memory device, coupled to the MPEG interface and the starter control circuit, storing the starting data so that the starter control circuit can read the starting data.

In a preferred embodiment of the present invention, the chip further comprises an external starting data interface coupled to a starting data provider, the memory reading the starting data defined by an external source via the external starting data interface. When the memory device is not stored with the starting data, the memory device reads the starting data provided by the starting data provider via the external starting data interface and stores the starting data provided by the starting data provider. When memory device cannot reads the starting data in a predetermined period, the memory device reads the starting data provided by the MPEG system and stores the starting data provided by the MPEG system. Then the DVD player enters into a standby mode. It takes about 0.8 second to complete the above step.

In a preferred embodiment of the present invention, the starting data provider is an EEPROM so that the designer can reprogram the starting data. The starter control circuit includes a logic circuit, so a program as required for a microprocessor is not precluded.

In a preferred embodiment of the present invention, the external control signal receiver receives an external control signal from an external controller and sends the external control signal to the starter control circuit and the MPEG interface. The starter control circuit controls the power control circuit in response to the starting data stored in the memory device and the external control signal. The external controller comprises a keyboard allowing a user to input the external control signal, and a remote controller inputting the external control signal via an infrared ray signal. The external control signal receiver comprises a keyboard detector detecting signals sent by the keyboard and an infrared ray receiver receiving the infrared ray signal sent by the remote controller. Because each DVD player manufacturer has its own remote controller, in this embodiment, any remote controller using NEC format is applicable for the present invention.

In a preferred embodiment of the present invention, the VFD can be replaced by other displays. Hence, it should be noted that any display that can be mounted on the DVD player is within the scope of the present invention.

The present invention uses a starter circuit to replace the microprocessor. Therefore, a program as required in a microprocessor is precluded to lessen the design complexity. In addition, the cost is further reduced because several circuits are integrated into a single chip. The present invention also provides a standard interface so that the user can control the DVD player by using a standard controller, while the DVD manufacturers may incorporate other features to better serve the consumers demand. The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF DRAWINGS

FIG. 1 is a block diagram of the power control system and the VFD drive circuit in a conventional DVD player.

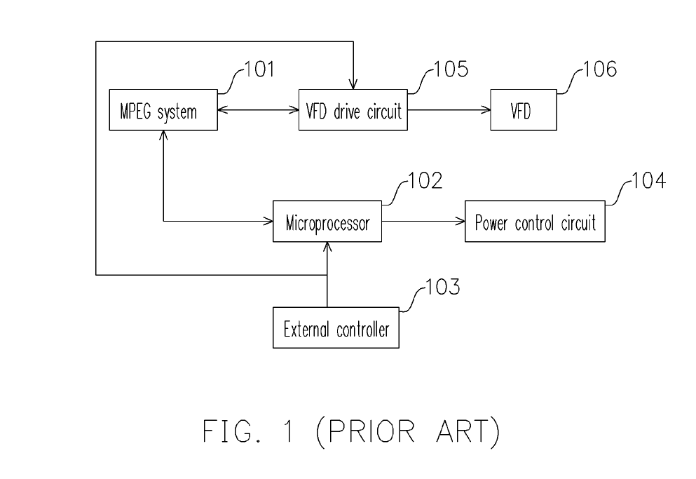

FIG. 2 is a block diagram of an integrated control chip with the power control in accordance with a preferred embodiment of the present invention.

FIG. 3 is the flow chart for reading the starting data in accordance with a preferred embodiment of the present invention.

### DETAILED DESCRIPTION

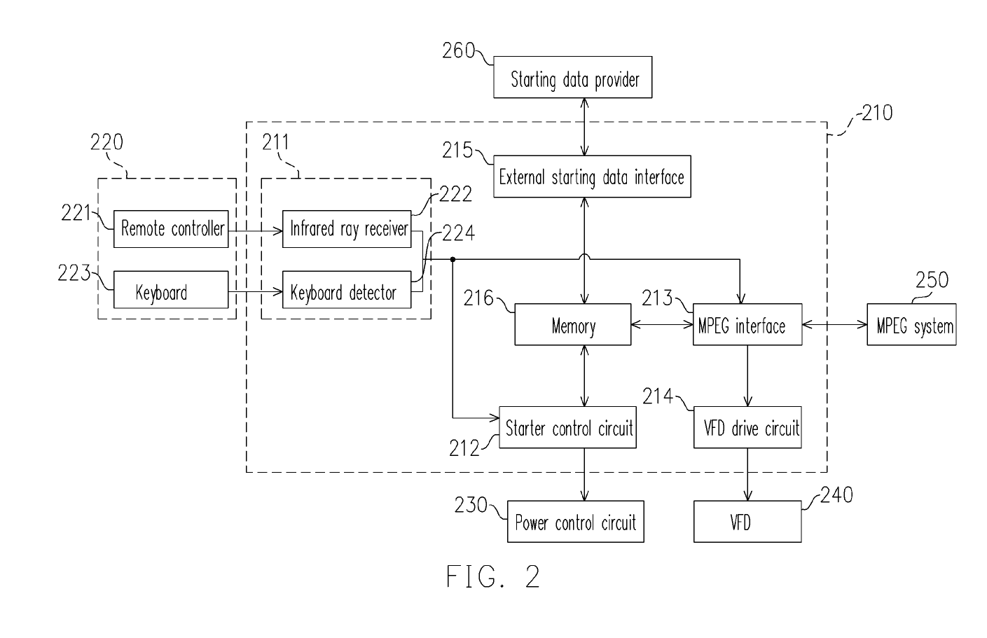

FIG. 2 is a block diagram of an integrated control chip with the power control in accordance with a preferred embodiment of the present invention. Referring to FIG. 2, the integrated chip 210 is coupled to an external controller 220, a power control circuit 230, a display 240 such as VFD, an MPEG system 250, and a starting data provider 260. In this embodiment, the external controller 220 includes a remote controller 221 and a keyboard 223 for sending an external control signal. In this embodiment, any remote controller using NEC format is applicable for the present invention. The starting data provider 260 is an EEPROM so that the designer can reprogram the starting data. The starter control circuit includes a logic circuit so that a program as required for a microprocessor is precluded.

The integrated control chip 210 includes an external control signal receiver 211 to receive the external control signal from the external controller 220. In this embodiment, the external control signal receiver 211 comprises a keyboard detector 224 for detecting signals sent by the keyboard and an infrared ray receiver 222 receiving the infrared ray signal sent by the remote controller. The external control signal receiver 211 then sends the external control signal to the starter control circuit 212 and the MPEG interface 213. The starter control circuit 212 is a logic circuit for determining whether the power control circuit 230 turns on the DVD player based on the external control signal. Hence, the microprocessor and the program for the microprocessor are not required. The MPEG interface 213 is an interface between the MPEG system 250 and the integrated control chip 210. The MPEG interface 213 can send the starting data to the memory 216 inside the integrated control chip 210. The MPEG interface 213 is coupled to the VFD drive circuit 214. The memory 216 is coupled to the MPEG interface 213 and the starter control circuit 212 for storing the starting data so that the starter control circuit 212 can read the starting data. The memory 216 is also coupled to the external starting data interface 215 to read the starting data defined by the external source from the external starting data provider 260, and to store the starting data.

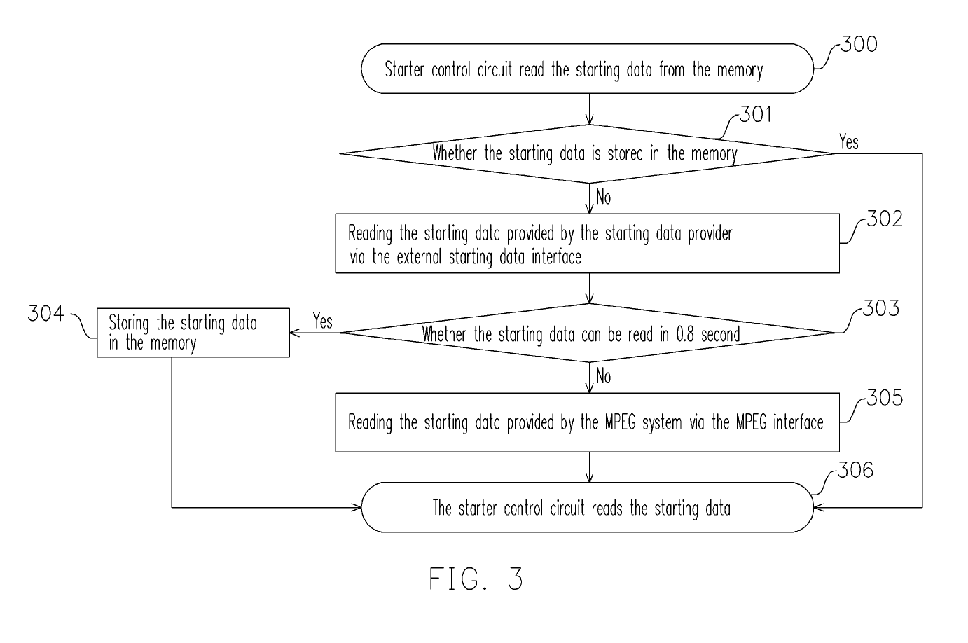

When the external controller 220 sends the external control signal to the DVD player for controlling the power, the external control signal receiver 211 then send the external control signal to the starter control circuit 212 and the MPEG interface 213. As the step 300 shown in FIG. 3, the starter control circuit 212 then reads the data from the memory device 216. The starter control circuit 212 will check if the memory device 216 stores the data as in step 301. If data is stored in the memory device 216, the starter control circuit 212 reads the starting data from the memory device 216 (step 306). If data is not stored in the memory device 216, the starting data will be provided by the starting data provider 260 via the external starting data interface 215 as in step 302. If the starting data can be read in 0.8 second from the external starting data provider 260, then the starting data will be stored in the memory device 216 as in step 304. If the starting data cannot be read in 0.8 second, then the MPEG system 250 will provide the starting data to the MPEG interface 213. The starting data then is stored in the memory 216 as in step 305. Further, the starter control circuit 212 reads the starting data as in step 306.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

1. An integrated control chip with a power control for a DVD player, said DVD player including an MPEG system, a power control circuit and a VFD, said chip comprising:
an MPEG interface between said MPEG system and said integrated control chip, said MPEG interface sending a starting data to said integrated control chip;
a VFD drive circuit, coupled to said MPEG interface, driving said VFD;
an external control signal receiver receiving an external control signal;
a starter control circuit, coupled to said external control signal receiver, determining whether said power control circuit turns on said DVD player based on said external control signal; and
a memory device, coupled to said MPEG interface and said starter control circuit, storing said starting data so that said starter control circuit reads said starting data.

2. The chip of claim 1, further comprising an external starting data interface coupled to a starting data provider, said memory device reading said starting data defined by an external source via said external starting data interface.

3. The chip of claim 2, wherein when said memory device is not stored with said starting data, said memory device reads said starting data provided by said starting data provider via said external starting data interface and stores said starting data provided by said starting data provider, and when said starting data is not read by said memory device through said external starting data interfacein a predetermined period, said memory device reads said starting data provided by said MPEG system and stores said starting data provided by said MPEG system.

4. The chip of claim 2, wherein said starting data provider is an EEPROM.

5. The chip of claim 1, wherein said external control signal receiver receives an external control signal from an external controller and sends said external control signal to said starter control circuit and said MPEG interface.

6. The chip of claim 5, wherein said starter control circuit controls said power control circuit in response to said starting data stored in said memory device and said external control signal.

7. The chip of claim 5, wherein said external controller comprises
a keyboard allowing a user to input said external control signal; and
a remote controller inputting said external control signal via an infrared ray signal.

8. The chip of claim 7, wherein said external control signal receiver comprises
a keyboard detector detecting signals sent by said keyboard; and
an infrared ray receiver receiving said infrared ray signal sent by said remote controller.

9. The chip of claim 1, wherein said starter control circuit comprises a logic circuit.

10. An integrated control chip with a power control for a DVD player, said DVD player including a power control circuit and an external controller, said chip comprising:
an external control signal receiver receiving an external control signal from said external controller;
a starter control circuit, couple to said external control signal receiver, determining whether said power control circuit turns on said DVD player based on said external control signal;
an MPEG interface between an MPEG system and an integrated control chip, said MPEG interface sending a starting data to said integrated control chip;
a memory device coupled to said MPEG interface and said starter control circuit, storing said starting data so that said MPEG interface reads said starting data; and
an external starting data interface coupled to a starting data provider, said memory device reading said starting data defined by an external source via said external starting data interface.

11. The chip of claim 10, further comprising:
a display drive circuit, coupled to said MPEG interface, driving said VFD.

12. The chip of claim 10, wherein when said memory device is not stored with said starting data, said memory reads said starting data provided by said starting data provider via said external starting data interface and stores said starting data provided by said starting data provider, and when said memory device does not read said starting data through said external starting data interface in a predetermined period, said memory device reads said starting data provided by said MPEG system and stores said starting data provided by said MPEG system, and said DVD player enters into a standby mode.

13. The chip of claim 10, wherein said starting data provider is an EEPROM.

14. The chip of claim 10, wherein said external control signal receiver receives said external control signal from said external controller and sends said external control signal to said starter control circuit and said MPEG interface.

15. The chip of claim 14, wherein said starter control circuit controls said power control circuit in response to said starting data stored in said memory and said external control signal.

16. The chip of claim 14, wherein said external controller comprises
a keyboard allowing a user to input said external control signal; and
a remote controller inputting said external control signal via an infrared ray signal.

17. The chip of claim 14, wherein said external control signal receiver comprises
a keyboard detector detecting signals sent by said keyboard; and
an infrared ray receiver receiving said infrared ray signal sent by said remote controller.

18. The chip of claim 10, wherein said starter control circuit comprises a logic circuit.
